(19) United States
(12) Patent Application Publication
(10) Pub. No.: US 2014/0278332 A1
(43) Pub. Date: Sep. 18, 2014

(54) System And Method For Performance Monitoring And Evaluation Of Solar Plants

(71) Applicant: INACCESS NETWORKS S.A., Athens (GR)

(72) Inventors: Ioannis Grammatikakis, Athens (GR); Spyridon Apostolakos, Athens (GR)

(73) Assignee: InAccess Networks S.A., Athens (GR)

(21) Appl. No.: 13/838,786

(22) Filed: Mar. 15, 2013

(51) Int. Cl. G06F 17/50

(52) U.S. Cl. CPC G06F 17/5009
USPC 703/18

(57) ABSTRACT

A monitoring system configured to monitor a solar plant is described. The monitoring system including a sensor configured to generate data based on an operating characteristic of a component. The monitoring system also includes a datalogger configured to receive data from the sensor. And, the monitoring system includes a server configured to receive the data from the datalogger and to generate a simulated output power for the component based on the data.

### FIELD

Embodiments of the invention relate to performance monitoring. In particular, embodiments of the invention relate to a system and method for performance monitoring and evaluation of a solar plant.

### BACKGROUND

A solar plant is an installation which produces energy using the sun as a source. Typically, a solar plant includes several components including photovoltaic (“PV”) modules, inverters, medium voltage transformers, electrical wiring to interconnect the various components, protection relays, fuses and circuit breakers for the safety of the installation. All the components of the solar plant are prone to failures or performance degradation. Failures of a solar plant may arise due to equipment failures, such as problems in the operation of an inverter or overheating of a transformer. Failures may also occur due to problems in the electrical installation such as a blown fuse or a die-cut cable. Performance degradations may occur for various reasons such as soiling, snow, shading and aging of the equipment. Another reason for performance degradations or underperformance of a solar plant includes design deficiencies, such as grouping of different PV modules per string, lowering the achieved MPPT (“maximum power point tracking”) point of the inverter. Further, failures caused by components or small parts included in equipment used in a solar plant appear as performance degradation of the equipment of the solar plant that includes the problematic components. For example, a failure of one or more strings appears as performance degradation of the inverter that the strings are connected to.

Such a failure results in false alarms resulting in extra time and cost to determine an exact cause of the failure that results in performance degradation of a solar plant. Current monitoring and evaluation systems used in solar plants cannot pinpoint a cause of failures without the use of an extensive installation of sensors in the field. This adds cost and complexity to a monitoring and an evaluation system.

### SUMMARY

A monitoring system configured to monitor a solar plant is described. The monitoring system including a sensor configured to generate data based on an operating characteristic of a component. The monitoring system also includes a datalogger configured to receive data from the sensor. And, the monitoring system includes a server configured to receive the data from the datalogger and to generate a simulated output power for the component based on the data.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of an example of a solar plant;

FIG. 2 illustrates a block diagram of a monitoring system according to an embodiment;

FIG. 3 illustrates a block diagram of a distributed monitoring system according to an embodiment;

FIG. 4 illustrates a flow diagram for monitoring a solar plant according to an embodiment;

FIG. 5 illustrates a method for processing data received from one or more components of a solar plant according to an embodiment;

FIG. 6 illustrates a flow diagram for generating a calibrated model according to an embodiment;

FIG. 7 illustrates a flow diagram for adapting coefficients for a model of one or more components according to an embodiment;

FIG. 8 illustrates an embodiment of a server for a monitoring system according to an embodiment; and

FIG. 9 illustrates an embodiment of a client or a user device according to an embodiment.

### DETAILED DESCRIPTION

Embodiments of a monitoring system are configured to receive data based on operating characteristics of one or more components of a solar plant. A monitoring system is configured to generate a simulated output power for one or more components based on data received. Further, a monitoring system is configured to receive or calculate an actual output power for one or more components of a solar plant. And, a monitoring system is configured to compare a simulate output power and an actual output power and is configured to generate an alert based on a result of the comparison. Embodiments of a monitoring system may also be configured to adapt one or more models of one or more components used to generate a simulated output power. A monitoring system, according to embodiments described herein, is configured to use such techniques to minimize generation of false alerts. Compared to other methods available for pinpointing failures in solar plants, the present disclosure offers a unified method that can be applied to the entire plant and any part of the plant down to a single module. Furthermore, it offers better performance by minimizing false alarms. The disclosure can also discover small-scale performance degradations without the use of extensive installation of sensors in the field.

FIG. 1 illustrates a block diagram of an example of a solar plant. A solar plant includes many components for the generation of power. A solar plant may include one or more of any of the components including, but not limited to, a photovoltaic (“PV”) module 12, an inverter 20, a transform 24 such as a step-up transformer and a set-down transformer, protection device (not shown), a transfer switch (not shown), an electrical panel (not shown), a circuit breaker (not shown), a surge arrester (not shown), a fuse (not shown), and a switch (not shown). A solar plant may also include one or more weather stations 28.

The number of PV modules 12 used in a solar plant depends on a nominal power of a solar plant as is known in the art. A solar plant may include a number of PV strings 16, with each PV string 16 including a plurality of PV modules 12 connected in series. The grouping of PV modules 12 into PV strings 16 may be decided at installation time using techniques known in the art. A solar plant may also include a plurality of PV arrays 18, with each PV array 18 including a one or more PV strings 16 connected in parallel. The grouping of PV strings 16 into PV arrays 18 may be decided at installation time using techniques known in the art. Several PV arrays 18 may be connected in parallel to a single inverter 20 that converts the direct current (“DC”) output of the PV modules 12 in the PV arrays 14 in to alternating current (“AC”) power.

A solar plant may also include a plurality of inverter groups 22, with each inverter group 22 including a plurality of inverters 20 coupled with one or more PV arrays 18. A solar plant may include a plurality of transformers 24, such as a step-up transformers, connected in parallel. A step-up transformer may be configured to raise a low voltage output of an inverter 20 to a medium voltage. In an embodiment, a low voltage output may be in a range including 50 volts up to and including 1000 volts. By way of example, and not limitation, a low voltage output in Europe may be 220 volts and a low voltage in the United States may be 110 volts. In an embodiment, a medium voltage is a voltage greater than 1000 volts. By way of example, and not limitation, a step-up transformer may be configured to raise a low voltage output to a medium voltage including 13 kilovolts (“kV”), 16.6 kV, or 20 kV. For example a transformer 24 may be configured to raise a low voltage output of an inverter 20 to a medium voltage of an electrical power system (“EPS”), which is also called utility grid. The number of transformers 24 used in a solar plant depends on a solar plant nominal power.

A solar plant may also include a point of common coupling (“PCC”) 26, which is a point of interconnection with an EPS. The solar plant is usually interconnected to the EPS so that the produced energy is forwarded to the customer loads. The Load Connection Point (“LCP”) 30, which is the point of interconnection of solar plant loads. Solar plant loads include solar plant auxiliary equipment that consume part of the power produced by the solar plant during the day and consume power from the EPS during the night. Solar plant loads may be connected in parallel to a PCC 26 via a transformer 24, such as a step-down transformer.

A solar plant may also include one or more electrical panels, which may be installed as part of an electrical installation of a solar plant. An electrical panel may include one or more of any component including, but not limited to, a circuit breaker, a surge arrester, a fuse, and a switch. A solar plant may also include one or more weather stations 28. The weather stations 28 may be configured to monitor environmental conditions at a solar plant.

FIG. 2 illustrates a block diagram of a monitoring system according to an embodiment. A monitoring system 102 includes one or more servers 104. A server 104 is coupled with one or more dataloggers 110a-c. In an embodiment, a server 104 may be coupled with a datalogger 110a-c using a network 108 including, but not limited to, a local access network (LAN), a wireless network, or other type of network. A datalogger 110a-c is coupled with one or more sensors 112a-c. A datalogger 110a-c may be coupled with a sensor 112a-c using a network including those described herein. As illustrated in FIG. 1, a datalogger 110a-c is coupled with one or more measurement equipment 114a-c.

A datalogger 110a-c is configured to receive data from a sensor 112a-c and/or measurement equipment 114a-c. In an embodiment, a datalogger 110a-c is configured to receive data from one or more sensors 110a-c and/or measurement equipment 114a-c in real time. A datalogger 110a-c, according to an embodiment, is configured to sample or acquire data from one or more of at least one of a sensor 110a-c and a measurement equipment 114a-c. In an embodiment, a datalogger 110a-c is configured to sample data from one or more of at least one of a sensor 110a-c and a measurement equipment 114a-c every minute. Another embodiment includes a datalogger 110a-c configured to sample data at an interval in a range including 0.1 second up to and including a minute. One skilled in the art would understand that a sampling interval may depend on the type of physical quantity being measured and the type of connection between a datalogger 110a-c and a sensor and/or a measurement equipment 114a-c.

In an embodiment, a datalogger 110a-c may be a programmable automation controller (“PAC”). A programmable automation controller is configured to process data received. In an embodiment, a programmable automation controller is configured to process data to reduce a number of data values to be used for further processing. Further, a programmable automation controller may be configured to generate values based on data received from one or more of at least one of a sensor 110a-c and a measurement equipment 114a-b.

According to an embodiment, a datalogger 110a-c, such as a programmable automation controller, is configured to process data received from one or more of at least one of a sensor 112a-c and a measurement equipment 114a-c based on a primary parameter interval (“PPI”). In an embodiment, a PPI is an integer multiple or sub-multiple of an hour. By way of example and not limitation, a PPI may be set to 15 minutes. A PPI is used as a processing window or duration for a datalogger 110a-c to acquire data from a sensor 112a-c and/or measurement equipment 114a-c. According to an embodiment, a datalogger 110a-c is configured to eliminate data received or acquired. A datalogger 110a-c may be configured to eliminate data based on determinations including, but not limited to, the data is incorrect, the data is out of scale, and a derivative of the data values is out of scale.

A datalogger 110a-c, according to an embodiment, is configured to determine data is incorrect if data is received or acquired from a sensor 112a-c and/or a measurement equipment that failed. A datalogger 110a-c may be configured to determine that data is out of scale if the data received or acquired is outside a set range for the type of data. A datalogger 110a-c may be configured to determine that a derivative of the data value is out of scale by generating an absolute value of a calculated derivative of at least 2 successive data values received or acquired and if the absolute value of the derivative is greater than a set range the values used for the calculation are not used for further processing. For example, a datalogger 110a-c is configured to calculate a derivative of data received including, but not limited to, voltage, current, power, or other data received or acquired from a sensor or a measurement equipment.

According to an embodiment, a datalogger 110a-c is configured to determine if a set of data received or acquired from a sensor 112a-c and/or a measurement equipment 114a-c is complete by comparing the number of data points based on a set threshold. If a datalogger 110a-c determines that received or acquired data includes a number of data points that is less than a set threshold for a PPI, the data is determined to be invalid. If a datalogger 110a-c determines that received or acquired data include a number of data points that is greater than a set threshold for a PPI, the datalogger 110a-c determines that the data is valid.

A datalogger 110a-c, according to an embodiment, having determined that the data is valid is configured to generate a mean value based on the data. A datalogger 110a-c generates a mean value by adding all the data points and dividing by the total number of data points. A datalogger 110a-c, according to an embodiment, is configured to store a generated mean value. According to an embodiment, a datalogger 110a-c is configured to receive or acquire power data from a sensor 112a-c and/or a measurement equipment 114a-c. A datalogger 110a-c may also be configured to receive or acquire current data and voltage data for a component from one or more sensors 112a-c and/or measurement equipment 114a-c and to generate a power value for a component based on the acquired current data and voltage data. In an embodiment, a data logger is configured to calculate an interval energy for a component.

In an embodiment, a sensor 112a-c and a measurement equipment 114a-c is configured to measure and/or to generate data based on operating characteristics of a component of a solar plant. An operating characteristic includes, but is not limited to a current, a voltage, a power, a temperature, an energy or other characteristic used to determine performance of a component. According to an embodiment, a sensor 112a-c and a measurement equipment 114a-c is configured to measure and/or to generate data based on a direct current (“DC”) power of a photovoltaic (“PV”) module, a PV string, or a PV array. A sensor includes but is not limited to, an ambient temperature sensor, a horizontal solar irradiance sensor (pyranometer), a plane of array (PoA) irradiance sensor, a wind speed sensor, a barometric pressure sensor, a water precipitation (rain gauge) sensor.

In a PV module, a temperature sensor may be installed to measure a temperature of the PV module temperature. A weather station may be configured to monitor environmental conditions at the solar plant, which may be used to quantify the solar plant production performance. A weather station may be configured to monitor environmental conditions by using sensors that may include, but is not limited to, an ambient temperature sensor, a horizontal solar irradiance sensor (pyranometer), a plane of array (PoA) irradiance sensor, a wind speed sensor, a wind direction sensor, a relative humidity sensor, a barometric pressure sensor, and a water precipitation sensor, such as a rain gauge.

A sensor may also include a reference cell configured to determine irradiance of one or more PV modules. In an embodiment, a reference cell is a circuit that is a PV cell in a PV module that is short-circuited. Such a reference cell is configured to generate a current that is directly proportional to an irradiance of a PV cell. In an embodiment, a reference cell is configured to determine a temperature of a PV cell using techniques known in the art. A temperature of a PV cell may be used, according to an embodiment, to generate a correction factor for an irradiance measurement of the PV cell.

Measurement equipment includes, but is not limited to a multimeter, a power meter, a power analyzer, a detection of gas, pressure and temperature (“DGPT”) relay, a Buchholz relay, a thermostat, a combiner box and a reference cell. An inverter may include one or more sensors and/or measurement equipment to acquire a number of operational characteristics and events. In an embodiment, operational characteristics may include, but are not limited to, output power, energy, current voltage, and frequency. Events, according to an embodiment, may include, but are not limited to, a status of an operation (i.e., wait, run, and stop), and a failure (i.e., grid fault, internal, errors, etc.). Additionally, a DC current of each PV array 16 may be monitored using combiner boxes configured to measure the DC current. In an embodiment, an input to and/or an output from a transformer 24 may be monitored using monitoring equipment such as a power meter or a power analyzer. A a power meter or a power analyzer may be coupled with a transform 24 on a primary windings (low voltage side) or a secondary windings (medium voltage side). The quality of the power delivered to the grid is monitored through a power meter and a protection device undertakes the task of automatically disconnecting the PV plant under certain conditions. The protection device may also act as an additional power meter. In an embodiment, a component in an electrical may be monitored through contacts connected to components of an electrical panel including but not limited to, one or more of any of a circuit breaker, a surge arrester, a fuse, and a switch.

The step-down transformer may provide a set of signals so that its operation and status can be monitored. In an embodiment, an LCP is monitored using a power meter. The loads can be fed with electrical power either by the EPS/solar plants production or by other power sources, depending on the position of a transfer switch.

In an embodiment, one or more of at least one of a sensor 112a-c and a measurement equipment 114a-c may be configured to measure and to generate data that represents a current and/or a voltage of components of a solar plant. When a sensor 112a-c or a measurement equipment 114a-c does not provide power data directly to a datalogger 110a-c, the datalogger 110a-c may be configured to determine an actual output power of a component based on current data and voltage data received from one or more of at least one of a sensor 112a-c and a measurement equipment 114a-c. According to an embodiment, a datalogger 110a-c is configured to determine an actual output power of a component based on a received current data and a received voltage data for a component by multiplying the current data by the voltage data using techniques such as those known in the art.

In an embodiment, a sensor 112a-c or a measurement equipment 114a-c is configured to only generate current data for a photovoltaic (“PV”) module, a PV string, or a PV array. In such a case, a datalogger 110a-c is configured to receive current data from a sensor 112a-c and a measurement equipment 114a-c for a component or group of components and configured to receive voltage data from another sensor 112a-c and/or a measurement equipment 114a-c. By way of example and not limitation, a datalogger 110a-c may receive current data from a sensor 112a-c or a measurement equipment 114a-c of a component, such as a photovoltaic (“PV”) module, a PV string, or a PV array and receive voltage data of the component from an inverter coupled with the component. A datalogger 110a-c may be configured to receive or acquire DC power of all or a subset of PV arrays connected to a single inverter. In an embodiment, a datalogger 110a-c is configured to receive or acquire a DC power from measurement equipment 114a-c including, but not limited to, an inverter or a power meter coupled with a DC input of the inverter.

Further, a datalogger 110a-c may be configured to receive or acquire a low voltage alternating current (“AC”) power of an inverter or a group of inverters. A datalogger 110a-c, according to an embodiment, is configured to receive or acquire a low voltage AC power from a measurement equipment 114a-c such as a power meter coupled with an AC output of an inverter or a group of inverters. In an embodiment, a datalogger 110a-c is configured to receive or acquire current data and voltage data of an inverter of group of inverters using techniques including those described herein and configured to generate a power of the inverter or of the group of inverters using techniques including those described herein.

A datalogger 110a-c may be configured to receive or acquire a low voltage AC power of a transformer. In an embodiment, a datalogger 110a-c is configured to receive or acquire a low voltage AC power of a transformer from a measurement equipment 114a-c such as a power meter coupled with a low voltage input of the transformer. In an embodiment, a datalogger 110a-c is configured to receive or acquire current data and voltage data of a transformer using techniques including those described herein and configured to generate a power of the transformer using techniques including those described herein.

According to an embodiment, a datalogger 110a-c may be configured to receive or acquire a medium voltage AC power of a transformer using techniques including those described herein. In an embodiment, a datalogger 110a-c is configured to receive or acquire a medium voltage AC power of a transformer from a measurement equipment 114a-c such as a power meter coupled with a medium voltage input of the transformer. In an embodiment, a datalogger 110a-c is configured to receive or acquire current data and voltage data of a transformer using techniques including those described herein and configured to generate a power of the transformer using techniques including those described herein.

A datalogger 110a-c may be configured to receive or acquire a medium voltage AC power of a solar plant at a point of common coupling (“PCC”), which is the point of interconnection with an electrical power system (“EPS”), using techniques including those described herein. In an embodiment, a datalogger 110a-c is configured to receive or acquire a medium voltage AC power of a solar plant at a PCC from a measurement equipment 114a-c such as a power meter coupled with the PCC. In an embodiment, a datalogger 110a-c is configured to receive or acquire current data and voltage data of a solar plant at a PCC using techniques including those described herein and configured to generate a power using techniques including those described herein.

According to an embodiment, a datalogger 110a-c may be configured to receive or acquire PoA irradiance data using techniques including those described herein. In an embodiment, a datalogger 110a-c is configured to receive or acquire PoA irradiance data from one or more sensors 112a-c. A sensor 112a-c configured to generate PoA irradiance data, according to an embodiment, may be placed at the inclination of a PV module. In an embodiment that uses a plurality of sensors 112a-c configured to generate PoA irradiance data, a datalogger 110a-c may be configured to receive or acquire PoA irradiance data from the plurality of sensors 112a-c and configured to generate an average PoA irradiance value based on the PoA irradiance data.

A datalogger 110a-c may be configured to receive or acquire ambient air temperature data using techniques including those described herein. In an embodiment, a datalogger 110a-c is configured to receive or acquire ambient air temperature data from one or more sensors 112a-c. In an embodiment that uses a plurality of sensors 112a-c configured to generate ambient air temperature data, a datalogger 110a-c may be configured to receive or acquire ambient air temperature data from the plurality of sensors 112a-c and configured to generate an average ambient air temperature value based on the ambient air temperature data.

In an embodiment, a datalogger 110a-c may be configured to receive or acquire module temperature data using techniques including those described herein. In an embodiment, a datalogger 110a-c is configured to receive or acquire module temperature data from one or more sensors 112a-c. In an embodiment that uses a plurality of sensors 112a-c configured to generate module temperature data, a datalogger 110a-c may be configured to receive or acquire module temperature data from the plurality of sensors 112a-c and configured to generate an average module temperature value based on the module temperature data.

According to an embodiment, a datalogger 110a-c may be configured to receive or acquire wind speed data using techniques including those described herein. In an embodiment, a datalogger 110a-c is configured to receive or acquire wind speed data from one or more sensors 112a-c. In an embodiment that uses a plurality of sensors 112a-c configured to generate wind speed data, a datalogger 110a-c may be configured to receive or acquire wind speed data from the plurality of sensors 112a-c and configured to generate an average wind speed value based on the wind speed data.

FIG. 3 illustrates a block diagram of a distributed monitoring system according to an embodiment. A distributed monitoring system includes a control center (“CC”) 202 and one or more solar plants 212, which may also be referred to as a solar plant subsystem (“SPS”). In an embodiment, a distributed monitoring system is configured to monitor a plurality of solar plants that are geographical dispersed. A solar plant 212 may be connected with a control center 202 through a communication network 210. A communication network 210 may include, but is not limited to, the Internet, other wide area networks, local area networks, metropolitan area networks, and other type of networks. In an embodiment, a communication network 210 is an internet protocol (“IP”) network. A CC 202 can also be configured to monitor a single solar plant. In an embodiment, a CC 202 may be physically located at a solar plant 212. According to an embodiment, a monitoring system optionally includes a server 213 that is located at a solar plant 212, such as a local plant server (“LPS”). An LPS may be configured to perform some or all functions of a control center 202 in an embodiment.

According to the embodiment illustrated in FIG. 3, a CC 202 includes one or more servers 204. In an embodiment, the number of servers 204 used in a CC 202 is based on a number of solar plants monitored by the CC 202 and/or a combined nominal power of the monitored solar plants. According to an embodiment using more than one server, a CC 202 may include, but is not limited to, a blade server system or multiple standalone servers. A CC 202 includes one or more databases 206. A database is coupled with one or more servers 104 through a network 205 such as those networks describe herein. A database 206 may include, but is not limited to, a storage area network (“SAN”), a dedicated data base server and memory.

In an embodiment, a CC 202 includes a gateway 208. A gateway 208 may be configured to communicate with one or more clients 102 using one or more protocols. In an embodiment a gateway 208 is configured to communicate with one or more clients 102 using short message service (“SMS”). A gateway 208 is coupled with one or more servers 204 and one or more databases 206 through a network 205.

As illustrated in FIG. 3, a solar plant 212 may optionally include a local plant server 213. In an embodiment including a local plant server 213, the local plant server 213 is coupled with one or more dataloggers 216a-c including those described herein. In an embodiment, a local plant server 213 may be coupled with a datalogger 216a-c using a network 214 including those described herein. A datalogger 216a-c is coupled with one or more sensors 222a-c. A datalogger 216a-c may be coupled with a sensor 222a-c using a network including those described herein. As illustrated in FIG. 3, a datalogger 216a-c is coupled with one or more measurement equipment 222a-c.

FIG. 4 illustrates a flow diagram for monitoring a solar plant according to an embodiment. At block 402, a monitoring system, according to an embodiment, receives one or more inputs, which includes data, from one or more sensors and/or measurement equipment using techniques including those described herein. In an embodiment, a monitoring system receives inputs, including but not limited to, a PoA irradiation (G), an ambient air temperature (Ta), a component temperature (Tm) and a wind speed (Ws) for one or more components in a solar plant. At block 404, a monitoring system generates a simulated output power for one or more components based on one or more received inputs.

In an embodiment, a monitoring system generates a simulated output power for one or more components based on one or more models. In an embodiment, a monitoring system generates a simulated output power for each type of a component based on a model for that type of component. A model may also be configured to generate a simulated output power for a group of components. According to an embodiment, a model is a set of coefficients that combines inputs received by a monitoring system for a component through a mathematical formula to generate a simulated output power for that component. In an embodiment, a mathematical formula is polynomial. A simulated output power generated for a component includes, but is not limited to, a simulated AC output power (“MPac”) and an interval energy (“MEac”).

By way of example and not limitation, a monitoring system may include a model for a PV module, an inverter coupled with the PV module and wiring coupling the PV module to the inverter. In an embodiment, a model is stored in a database of a monitoring system. In an embodiment, a model generates a simulated output power based on the received inputs: the PoA irradiation (G), the ambient air temperature (Ta), the module temperature (Tm) and the wind speed (Ws) for the PV module, inverter, and wiring.

As illustrated in FIG. 4 at block 406, a monitoring system receives an actual output power for one or more components using techniques including those described herein. At block 408, a monitoring system compares a simulated output power of one or more components with an actual output power of the one or more components. In an embodiment, a monitoring system is configured to compare a simulated output power with an actual output power by subtracting the simulated output power from the actual output power. A monitoring system, according to an embodiment, may be configured to compare a simulated output power with an actual output power by determining which value is greater. In an embodiment, a monitoring system may compare a simulated output power with an actual output power by determining a percentage difference between the actual output power and the simulated output power.

At block 410, a monitoring system determines if a result of comparing a simulated output power with an actual output power is within a threshold. In an embodiment, a threshold may be set for each component or a group of components that a monitoring system is configured to monitor. A threshold for a component or a group of components, according to an embodiment, is stored in a database. In an embodiment, a threshold may be percentage difference between an actual output power and a simulated output power. A threshold may be a magnitude difference between an actual output power and a simulated output power. In an embodiment, a threshold may be a range determined to be a normal operating condition. For an example, a threshold is a five percent difference between the actual output power and the simulated output power. For such an example, if the result of comparing an actual output power with the simulated output power is determined to be above a five percent difference, a monitoring system performs hysteresis, block 412.

At block 412 as illustrated in FIG. 4, a monitoring system performs hysteresis if a monitoring system determines a result of a compare is beyond a threshold. A monitoring system performs hysteresis to prevent generating a false alert. A monitoring system, according to an embodiment, is configured to perform hysteresis by performing steps illustrated in blocks 402-410 for a number of times or over a period of time to see if a result of a compare continues to be beyond a threshold. If after performing hysteresis, a result of comparing an actual output power with the simulated output power is determined to be beyond a threshold, a monitoring system generates an alert, as illustrated at block 414. An alert includes, but is not limited to, an email, an SMS, a push notification, a visual indicator, an audible indicator, or other indicator.

FIG. 5 illustrates a method for processing data from one or more components of a solar plant according to an embodiment. Referring to block 502, a monitoring system receives or acquires data from one or more components using techniques including those described herein. In an embodiment, a datalogger, such as a PAC, is configured to receive or acquire data from one or more components of a solar plant. A monitoring system analyzes the data received, as illustrated at block 504. In an embodiment, a datalogger is configured to analyze data received from one or more components. Analyzing the data, according to an embodiment, includes collecting data that is received during a time interval, which may be referred to as a processing window or a primary parameter interval (“PPI”). In an embodiment, a PPI is a multiple of an hour. A PPI also may be a sub-multiple of an hour. By way of example, and not limitation, a PPI is set to be fifteen minutes. According to an embodiment, a monitoring system analyzes received data to determine if data from a component is received within a PPI. Data collected within a PPI forms a data set for further evaluation.

A monitoring system, according to an embodiment, analyzes data received from one or more components to determine if the data is incorrect data. In an embodiment, a monitoring system determines that data is incorrect data if the data is received from a sensor or measurement equipment during a failure period of the sensor or measurement equipment. In an embodiment, a monitoring system determines a failure period occurred if the monitoring system does not receive data from a sensor or measurement equipment for a period of time. A monitoring system may determine that a failure period occurred based on a signal or message received from a sensor or measurement equipment that indicates a failure of the sensor or measurement equipment. In an embodiment, a datalogger is configured to discard or ignore data received from a sensor or a measurement equipment that occurred during a failure period.

At block 506 as illustrated in FIG. 5, a monitoring system determines if the received data is out-of-scale data. In an embodiment, a monitoring system determines that received data is out-of-scale data based on a set measurement range. If data is received that is greater than a maximum value in a measurement range or less than a minimum value in the measurement range, a monitoring system discards or ignores the data. A measurement range, according an embodiment, may be set based on any number of factors including, but not limited to, typical operation characteristics of a component, historic range of nominal operation values for data, and design constraints of a solar plant or component. In an embodiment, a datalogger is configured to determine if data fails within a measurement range by comparing data to a maximum and a minimum value of a measurement range using techniques known the art for comparing values.

A monitoring system determines if a derivative of data is out-of-scale, as illustrate at block 508 in FIG. 5. In an embodiment, a monitoring system determines if derivative data is out-of-scale by calculating an absolute value of a derivative based on a plurality of successive data values received from a sensor or measurement equipment. In an embodiment, a derivative is based on two successive data values. A monitoring system, according to an embodiment, determines if an absolute value of a derivative is within a measurement range, using techniques including those describe herein. A monitoring system may determine if an absolute value of a derivative is greater than a reference value. If a derivative is outside a measurement range or greater than a reference value, a monitoring system discards or ignores all data used to determine the derivative. In an embodiment, a datalogger is configured to determine if a derivative of data is out-of-scale. Data that is received that is not discarded or ignored forms a data set.

At block 510 illustrated in FIG. 5, a monitoring system determines if a data set includes a number of data that is equal to or greater than a threshold. In an embodiment, if a data set is less than a threshold, a monitoring system determines that the data set is invalid and discards the data set. If a monitoring system determines that a data set includes a number of data that is greater than a threshold, the monitoring system, according to an embodiment, generates a mean of the data set to form a PPI value, at block 512. In an embodiment, a datalogger is configured to generate a mean of a data set using techniques know in the art for calculating a mean.

At block 514 as illustrated in FIG. 5, a monitoring system processes a PPI value to determine performance characteristics of a solar plant. In an embodiment, a datalogger is configured to process a PPI value. Processing a PPI value includes but is not limited to, calculating an energy value based on a PPI value, storing a PPI value, transmitting a PPI value, and generating a value based on a PPI value. In an embodiment, a monitoring system processes a PPI value by using the PPI value to generate an energy value. A monitoring system may be configured to use either power or an interval energy for monitoring a solar plant. In an embodiment, a PPI value is an actual output power used by a monitoring system to compare with a simulated output power using techniques including those described herein. In an embodiment, a PPI value is transmitted by a datalogger to a server. A server, according to an embodiment, may store a received PPI value in a database and/or use a received PPI value for comparing with a simulated output power for monitoring a solar plant as described herein.

FIG. 6 illustrates a flow diagram for generating a calibrated model according to an embodiment. In an embodiment, an initial model for one or more components may be generated based on a publicly available database, a vendors' datasheets, and/or a one or more measurements performed on a component or components, such as a flash report. In an embodiment, an initial model is tested on a real plant and calibrated. An actual plant design and construction including, but not limited to, a length of cables, a type of cabling, an impedance mismatch, and not accurate sorting of modules will cause a performance of a component or a group of components to deviate from its initial model. For this reason, an initial model may be tested and calibrated against an actual installation.

At block 602, a monitoring system receives one or more inputs, which includes data, from one or more sensors and/or measurement equipment using techniques including those described above. In an embodiment, a monitoring system receives inputs, including but not limited to, a PoA irradiation (G), an ambient air temperature (Ta), a component temperature (Tm) and a wind speed (Ws) for one or more components in a solar plant. At block 604, a monitoring system generates a simulated output power for one or more components based on one or more received inputs. In an embodiment, a monitoring system generates a simulated output power for one or more components based on one or more models using techniques including those described herein. As illustrated in FIG. 6 at block 606, a monitoring system receives an actual output power or interval energy for one or more components using techniques including those described herein.

At block 608 as illustrated in FIG. 6, in an embodiment, a monitoring system compares a generated simulated output power and a received actual output power using techniques including those described herein. A block 610, a monitoring system determines new coefficients for a model based on a result of comparing the generated simulated output power and a received actual output power. In an embodiment, a monitoring system determines new coefficients by adjusting coefficients values based on a moving average approach that spans several PPIs. For an embodiment, one coefficient value is adjusted per iteration by increasing or decreasing its value by a small percentage. By way of example, but not limitation, a coefficient value may be adjusted by two percent; however, one skilled in the art would understand that any magnitude of adjustment could be used. According to an embodiment, a coefficient value is increased and a monitoring system determines if a difference between a simulated output power and an actual output power is decreasing, the monitoring system continues to increase the coefficient value until the difference is no longer decreasing. At a point where the difference between the simulated output power and the actual output power is not decreasing, a monitoring system is configured to adjust another coefficient value. In a embodiment, a monitoring system may decease a coefficient value to minimize a difference between a simulated output power and an actual output power using a similar technique as described above. In an embodiment, a monitoring system continues to iterate one or more coefficient until the difference between a simulated output power and the actual output power is within a threshold. A monitoring system, according to an embodiment, may adjust coefficient values so as to make the simulated output power to equal the actual output power.

Referring to FIG. 6 at block 612, a monitoring system determines if a simulated output power based on the determined new coefficients and an actual output power are within a threshold, for example by using techniques including those described herein. In an embodiment, if a monitoring system determines a simulated output power and an actual output power are within a threshold is within a percentage difference, the calibration process ends. According to an embodiment, a monitoring system may repeat the process at blocks 602-612 until a simulated output power and an actual output power are within a set threshold. In an embodiment, a threshold may set at a 0.5% percentage difference. At block 614, a monitoring system generates a new model based on the determined coefficients when the calibration ends. In an embodiment, a monitoring system stores a new model based on the new coefficients in a database and will be used for all subsequent processing.

In an embodiment, a monitoring system may perform a model calibration procedure during the first period of operation of the solar plant, when all equipment is new and there are no aging effects. According to an embodiment, the procedure is performed when a part of a solar plant that is modeled presents no component or group of components in failure and all the modules included in the model are clear to avoid performance degradation due to soiling. A monitoring system may perform a calibration procedure when a PoA irradiance is above a threshold, for example this threshold can be set to 500 watts per square meter (W/m2), so as to avoid cloudy intervals. According to an embodiment, a monitoring system may perform a calibration procedure at a select time period when the sun lies relatively high in the sky to avoid performance degradation due to possible shadowing. In an embodiment, a calibration process may span several PPIs and may last a few days depending on the weather conditions.

FIG. 7 illustrates a flow diagram for adapting coefficients for a model of one or more components according to an embodiment. In an embodiment, a monitoring system performs a model coefficient adaptation procedure to compensate for effects including, but not limited to, aging of a component, soiling of a component, and shadowing, such as from a plant or other object. At block 702, a monitoring system receives one or more inputs, which includes data, from one or more sensors and/or measurement equipment using techniques including those described above. In an embodiment, a monitoring system receives inputs, including but not limited to, a PoA irradiation (G), an ambient air temperature (Ta), a component temperature (Tm) and a wind speed (Ws) for one or more components in a solar plant.

At block 704, a monitoring system generates a simulated output power for one or more components based on one or more received inputs using techniques including those described herein. As illustrated in FIG. 7 at block 706, a monitoring system receives an actual output power or an interval energy for one or more components using techniques including those described herein. At block 708, a monitoring system determines if a received PoA irradiation is above a threshold, such as an irradiance calibration threshold. In an embodiment, an irradiance calibration threshold is set to a value of 500 watts per square meter (W/m2). If a received PoA irradiation is below an irradiance calibration threshold, the process for adapting coefficients for a model would end. However, if a received PoA irradiation is equal to or above an irradiance calibration threshold, a monitoring system compares a simulated output power with an actual output power, as illustrated in FIG. 7 at block 710. In an embodiment, a monitoring system compares a simulated output power with an actual output power using techniques including those described herein. According to an embodiment, a monitoring system compares a simulated output power with an actual output power by determining a percentage difference between the actual output power and the simulated output power. If a determined percentage difference is equal to or above a threshold, such as an alert threshold, the process for adapting coefficients for a model would end. However, if a determined percentage difference is below an alert threshold, a monitoring system determines new coefficients for a model, at block 712, using techniques including those described herein.

Referring to FIG. 7 at block 714, a monitoring system generates a new temporary model for one or more components based on the new coefficients. A monitoring system, at block 716, generates a first difference based on a first simulated output power and an actual output power. In embodiment, a monitoring system generates a first difference by subtracting a first simulated output power from an actual output power. At block 718, a monitoring system generates a second simulated output power based on a temporary model. A monitoring system, at block 719, generates a second difference based on a second simulated output power and an actual output power. In embodiment, a monitoring system generates a second difference by subtracting a second simulated output power from an actual output power.

A monitoring system, at block 720, compares a first difference with a second difference. In an embodiment, a monitoring system compares a first difference with a second difference by calculating a percentage difference between the first difference and the second difference. At block 722, a monitoring system determines if a comparison between a first difference and a second difference is above a threshold. If a monitoring system determines a comparison between a first difference and a second difference is equal to or below a threshold, the monitoring system discards the temporary model. In an embodiment, a threshold is set at a value of two percent, such that, if a comparison between a first difference and a second difference is a percentage difference greater than two percent, a monitoring system performs hysteresis.

A monitoring system performs hysteresis to prevent generating a false alert. A monitoring system, according to an embodiment, is configured to perform hysteresis by performing steps illustrated in blocks 702-724 for a number of times or over a period of time to see if a result of a compare continues to be above a threshold. If after performing hysteresis, a result of comparing an actual output power with the simulated output power is determined to be above a threshold, a monitoring system generates an alert, as illustrated at block 726, using techniques as described herein. A monitoring system, at block 728, determines to implement a temporary model to generate subsequent simulated output power. In an embodiment, a monitoring system determines to implement a temporary model in response to receiving a user input indicating an acceptance of the temporary model. A monitoring system determines to discard a temporary model, according to an embodiment, in response to receiving a user input indicating to discard the temporary model.

A monitoring system, according to an embodiment, is configured to implement a temporary model for a period of time before reverting back to using an initial model. For example, a monitoring system may implement a temporary model to prevent false alarms caused by conditions that can be changed including, but not limited to, soiled modules that can be cleaned and shadowing caused by an object that can be removed. As a result when an alert is generated, personnel may check if there are problems with soiling or shadowing and act accordingly by cleaning the modules or removing the shadow causing objects. Once the problems are remedied, a monitoring system can be configured to reuse an initial model. For such an embodiment, a monitoring system may save an initial model when implementing a temporary model so that the monitoring system may be configured to revert back to using the initial model upon receiving an input from a user to do so. This is done in order for a monitoring system to produce accurate alerts until the corrective actions are made by personnel. For an example, an alert is generated because of aging components, which typically cannot be remedied, personnel may choose to discard an initial model when implementing a temporary model to ensure the monitoring system continues working correctly to prevent false alarms. According to an embodiment, a monitoring system is configured to store initial models for future reference and comparisons across all coefficient sets whenever a temporary model is implemented by the monitoring system.

According to an embodiment, various sets of saved models can be used to evaluate the effect of aging, soiling and shadowing on the production of the solar plant or parts of the plant down to a module level. In an embodiment, a monitoring system stores in a database each set of coefficients for a model corresponding to times that a coefficient update alert has been generated and the monitoring system provides a user the ability to submit a description for the change (e.g., aging, soiling, and shadowing). Storing simulated output powers of two or more models provides the ability to compare so that the effects of aging, soiling or shadowing on a solar plant can be quantified.

FIG. 8 illustrates an embodiment of a server for a monitoring system 802 that implements the methods described herein. The system 802, according to an embodiment, includes one or more processing units (CPUs) 804, one or more communication interface 806, memory 808, and one or more communication buses 810 for interconnecting these components. The system 802 may optionally include a user interface 826 comprising a display device 828, a keyboard 830, a touchscreen 832, and/or other input/output devices. Memory 808 may include high speed random access memory and may also include non-volatile memory, such as one or more magnetic or optical storage disks. The memory 808 may include mass storage that is remotely located from CPUs 804. Moreover, memory 808, or alternatively one or more storage devices (e.g., one or more nonvolatile storage devices) within memory 808, includes a computer readable storage medium. The memory 808 may store the following elements, or a subset or superset of such elements:

an operating system 812 that includes procedures for handling various basic system services and for performing hardware dependent tasks;

a network communication module 814 (or instructions) that is used for connecting the system 802 to other computers, clients, peers, systems or devices via the one or more communication network interfaces 806 and one or more communication networks, such as the Internet, other wide area networks, local area networks, metropolitan area networks, and other type of networks;

a communication adapter module (“CAM”) 816 (or instructions) for acquiring or receiving data from a solar plant and/or conveying data to a solar plant, according to an embodiment, a CAM is coupled with one or more dataloggers to acquire, to receive, and to convey data between a server and one or more components of a solar plant;

an application logic module (“ALM”) 818 (or instructions) for determining coefficients, generating models, generating simulated output power; analyzing data; and performing other mathematical, analytical, and logical calculations;

a notification server module (“NSM”) 820 (or instructions) for generating an alert, which includes, but are not limited to, a short message service (“SMS”), an e-mail, or pop-up notification;

a reporting server module (“RSM”) 822 (or instructions) for generating and delivering reports to a user, for example, via a client device; and

a front-end-server (“FES”) 824 (or instructions) for formatting data into a structured presentation format for displaying information about a solar plant based on data acquired or received from one or more sensors and/or measurement equipment, for example by using web technologies including those known in the art.

In an embodiment, a monitoring system is configured to generate a report of a single or multiple alerts related to a specific time period accompanied with backing evidence from actual data stored in a database. According to an embodiment, a monitoring system is configured to generate a report and send a report to a client through an RSM. In an embodiment, a monitoring system is configured for modification of its operating characteristics by a user through an FES. A user may modify characteristics of a monitoring system, including but not limited to, a threshold value, how hysteresis is performed, a PPI value, or other setting of a monitoring system.

Although FIG. 8 illustrates system 802 as a computer that could be a client and/or a server system, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 8 could be implemented on a single server or client and single items could be implemented by one or more servers or clients. The actual number of servers, client, or modules used to implement a system 802 and how features are allocated among them will vary from one implementation to another, and may depend in part on the amount of data traffic that the system must handle during peak usage periods as well as during average usage periods. In addition, some modules or functions of modules illustrated in FIG. 8 may be implemented on one or more one or more systems remotely located from other systems that implement other modules or functions of modules illustrated in FIG. 8.

FIG. 9 illustrates an embodiment of a client 102 or user device, that implements the methods described herein, includes one or more processing units (CPUs) 902, one or more network or other communications interfaces 904, memory 914, and one or more communication buses 906 for interconnecting these components. The client 102 may include a user interface 908 comprising a display device 910, a keyboard 912, a touchscreen 913 and/or other input/output device. Memory 914 may include high speed random access memory and may also include non-volatile memory, such as one or more magnetic or optical storage disks. The memory 914 may include mass storage that is remotely located from CPUs 902. Moreover, memory 914, or alternatively one or more storage devices (e.g., one or more nonvolatile storage devices) within memory 914, includes a computer readable storage medium. The memory 914 may store the following elements, or a subset or superset of such elements:

an operating system 916 that includes procedures for handling various basic system services and for performing hardware dependent tasks;

a network communication module 918 (or instructions) that is used for connecting the client 102 to other computers, clients, servers, systems or devices via the one or more communications network interfaces 904 and one or more communications networks, such as the Internet, other wide area networks, local area networks, metropolitan area networks, and other type of networks; and

a client application 920 including, but not limited to, a web browser, a document viewer or other application for viewing information; and

a webpage 922 including one generated by an FES as described herein and configured to receive a user input to communicate with a monitoring system.

According to an embodiment, user device 102 may be any device interacting with a monitoring system as described herein that includes, but is not limited to, a mobile phone, a computer, a tablet computer, a personal digital assistant (PDA) or other mobile device.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A monitoring system configured to monitor a solar plant comprising:
a sensor configured to generate data based on an operating characteristic of a component;
a datalogger configured to receive data from said sensor; and
a server configured to receive said data from said datalogger and to generate a simulated output power for said component based on said data.

2. The monitoring system of claim 1, wherein said server is configured to compare said simulated output power with an actual output power of said component.

3. The monitoring system of claim 1, wherein said server is configured to generate a simulated output power for said component based on a model for said component.

4. The monitoring system of claim 3, wherein said server is configured to generate a new model based on said data received from said sensor.

5. The monitoring system of claim 3, wherein said server is configured to adapt coefficients for said model.

6. The monitoring system of claim 1, wherein said datalogger is configured to generate a PPI value based on said data received from said sensor.

7. The monitoring system of claim 1, wherein said datalogger is a programmable automation controller.

8. The monitoring system of claim 7, wherein said datalogger is configured to determine an actual output power based on current data and voltage data from said sensor.

9. The monitoring system of claim 1, wherein said server is located at a control center remotely located from said solar plant.

10. The monitoring system of claim 4 wherein, said control center is configured to receive information from a datalogger located at a second solar plant.

11. The monitoring system of claim 1 wherein, said datalogger is coupled with a server through an Internet Protocol network.

12. A monitoring system configured to monitor a solar plant comprising:
memory;
one or more processors; and
one or more modules stored in memory and configured for execution by the one or more processors, the modules comprising:
a communications adapter module (“CAM”) configured to receive a first set of data from a solar plant;
An application logic module (“ALM”) configured to generate a plurality of coefficients based on said first set of data and configured to generate a simulated output power based on said first set of data; and
a notification server module (“NSM”) configured to generate an alert based on said simulated output power.

13. The monitoring system of claim 12, wherein said CAM is configured to receive a first set of data from a datalogger at said solar plant.

14. The monitoring system of claim 12, wherein said alert includes at least one of a short message service (“SMS”), an e-mail, and a pop-up notification.

15. The monitoring system of claim 12 further comprising a reporting server module (“RSM”) configured to generate a report.

16. The monitoring system of claim 15 further comprising a front-end-server (“FES”) configured to format data generated by said monitoring system into a structured presentation format.

17. A method for monitoring a solar plant comprising:
receiving one or more inputs from one or more sensors based on data for a component;
generating a simulated output power based on one or more inputs;
receiving an actual output power for said component;
comparing said simulated output power with said actual output power;
determining if a result of said compare is within a threshold; and
generating an alert if said result is greater than said threshold.

18. The method of claim 17, wherein said simulated output power is generated using a model of said component.

19. The method of claim 18 further comprising generating a new model for said component.

20. The method of claim 18 further comprising adapting one or more coefficients of said model.
